(19) United States
(12) Patent Application Publication
(10) Pub. No.: US 2024/0422589 A1
(43) Pub. Date: Dec. 19, 2024

(54) COMMUNICATION CONTROL METHOD

(71) Applicant: KYOCERA Corporation, Kyoto (JP)

(72) Inventors: Masato FUJISHIRO, Yokohama-shi (JP); Hiroyuki URABAYASHI, Yokohama-shi (JP); Mitsutaka HATA, Yokohama-shi (JP)

(73) Assignee: KYOCERA Corporation, Kyoto (JP)

(21) Appl. No.: 18/823,315

(22) Filed: Sep. 3, 2024

Related U.S. Application Data
(63) Continuation of application No. PCT/JP2023/007489, filed on Mar. 1, 2023.

(30) Foreign Application Priority Data
Mar. 2, 2022 (JP) 2022-032193

(51) Int. Cl. H04W 24/02; H04L 5/00; H04W 60/04; H04W 76/19

(52) U.S. Cl. CPC H04W 24/02; H04L 5/0053; H04W 60/04; H04W 76/19

(57) ABSTRACT

In an aspect, a communication control method is a communication control method in a wireless communication system. The communication control method includes a step of transmitting, by a first communication node included in a network, a predetermined message to a second communication node. The communication control method includes a step of transmitting, by the second communication node, tag information read from a wireless tag to the first communication node in response to receiving the predetermined message.

### RELATED APPLICATIONS

The present application is a continuation based on PCT Application No. PCT/JP2023/007489, filed on Mar. 1, 2023, which claims the benefit of Japanese Patent Application No. 2022-032193 filed on Mar. 2, 2022. The content of which is incorporated by reference herein in their entirety.

### TECHNICAL FIELD

The present disclosure relates to a communication control method in wireless communication systems.

### BACKGROUND

In The Third Generation Partnership Project (3GPP), which is a standardization project for mobile communication systems, Passive IoT has been discussed (e.g., see Non-Patent Documents 1 to 3).

The passive IoT is a technology that supports, for example, ultra-low power devices with ultra-low costs.

### CITATION LIST

### Non-Patent Literature

Non-Patent Document 1: 3GPP Contribution RP-212688

Non-Patent Document 2: 3GPP Contribution RP-213368

Non-Patent Document 3: 3GPP Contribution RP-213369

### SUMMARY

In a first aspect, a communication control method is a communication control method in a wireless communication system. The communication control method includes a step of transmitting, by a first communication node included in a network, a predetermined message to a second communication node. The communication control method includes a step of transmitting, by the second communication node, tag information read from a wireless tag to the first communication node in response to receiving the predetermined message.

In a second aspect, a communication control method is a communication control method in a wireless communication system. The communication control method includes a step of performing, on a second communication node by a first communication node included in a network, a configuration of monitoring of a wireless tag. The communication control method includes a step of periodically reading, by the second communication node, tag information from the wireless tag in accordance with the configuration. The communication control method includes a step of transmitting, by the second communication node, predetermined tag information to the first communication node when tag information read from the wireless tag at a first timing is different from tag information read from the wireless tag at a second timing subsequent to the first timing. The predetermined tag information includes either difference information indicating a difference between the tag information read at the first timing and the tag information read at the second timing or the tag information read at the second timing.

In a third aspect, a communication control method is a communication control method in a wireless communication system. The communication control method includes a step of reading, by a user equipment, tag information from a wireless tag in response to detecting a predetermined event. The communication control method includes a step of transmitting, by the user equipment, the tag information to a communication node included in a network. The predetermined event includes any one of Registration Area Update, Tracking Area Update, RAN-based Notification Area Update, handover, RRC connection reestablishment (RRC Reestablishment), RRC connection resume (RRC Resume), or RRC connection setup (RRC Setup).

In a fourth aspect, a communication control method is a communication control method in a wireless communication system. The communication control method includes a step of performing, on a second communication node by a first communication node included in a network, an indication of processing on a wireless tag. The communication control method includes a step of performing, by the second communication node, the processing on the wireless tag in accordance with the indication.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a wireless tag according to the first embodiment.

FIG. 5 is a diagram illustrating a configuration example of a protocol stack for a user plane according to the first embodiment.

FIG. 6 is a diagram illustrating a configuration example of a protocol stack for a control plane according to the first embodiment.

FIG. 7 is a diagram for explaining a problem in a passive IoT according to the first embodiment.

FIGS. 8A and 8B are diagrams for explaining a scenario a according to the first embodiment.

FIGS. 9A to 9C are diagrams for explaining a scenario b according to the first embodiment.

FIG. 10 is a diagram for explaining a scenario c according to the first embodiment.

FIG. 11 is a diagram illustrating an operation example according to the first embodiment.

FIG. 12 is a diagram illustrating an operation example according to a second embodiment.

FIG. 13 is a diagram illustrating an operation example according to a third embodiment.

FIG. 14 is a diagram illustrating an operation example according to a fourth embodiment.

FIG. 15 is a flowchart illustrating an operation example according to a fifth embodiment.

FIG. 16 is a diagram illustrating an operation example according to a sixth embodiment.

FIG. 17 is a diagram illustrating an operation example according to a seventh embodiment.

FIG. 18 is a diagram illustrating an operation example according to an eighth embodiment.

FIG. 19 is a diagram illustrating an operation example according to a ninth embodiment.

### DESCRIPTION OF EMBODIMENTS

In an aspect, a network or a communication node is allowed to appropriately

communicate with a wireless tag in a wireless communication system.

In an embodiment, a wireless communication system is described with reference to the drawings. In the description of the drawings, the same or similar parts are denoted by the same or similar reference signs.

### First Embodiment

### Configuration Example of Wireless Communication System

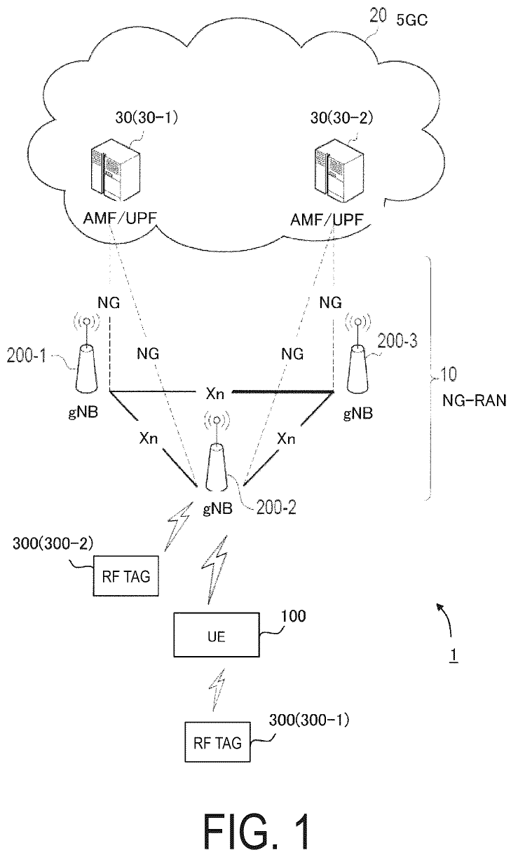

FIG. 1 is a diagram illustrating a configuration example of a wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may be at least partially applied. A system of the sixth or subsequent generation (6G) system may be at least partially applied as the mobile communication system. Note that the wireless communication system 1 may be the mobile communication system.

The wireless communication system 1 includes a User Equipment (UE) 100, a 5G radio access network (Next Generation Radio Access Network (NG-RAN)) 10, and a 5G Core Network (5GC) 20, and a Radio Frequency (RF) tag 300. The 5GC 20 may be hereinafter simply referred to as a core network (CN) 20.

The UE 100 is a mobile wireless communication apparatus. The UE 100 may be any apparatus as long as it is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility controls and the like for the UE 100. The AMF 30 manages mobility of the UE 100 by communicating with the UE 100 by using Non-Access Stratum (NAS) signaling. The UPF controls data transfer. The AMF 30 and the UPF are connected to the gNB 200 via an NG interface, which is an interface between the base station and the core network.

An RF tag (or wireless tag, and may be referred to as a “wireless tag”) 300 is a wireless communication apparatus capable of wireless communication with the UE 100 or the gNB 200. The wireless tag 300 is also an information medium including a built-in memory to and from which data or the like is written or read using radio waves or electromagnetic fields. The wireless tag 300 is, for example, an Internet of Things (IoT) device that is extremely small, thin, lightweight, and low complexity.

### Configuration Example of UE

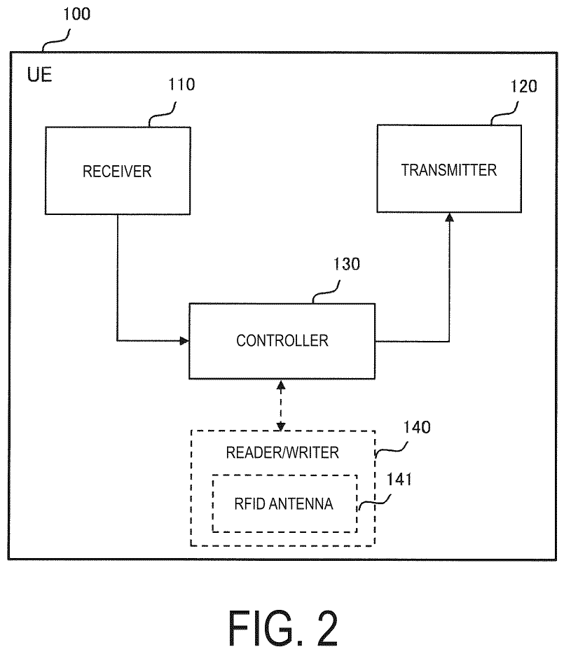

FIG. 2 is a diagram illustrating a configuration example of the UE 100 (user equipment) according to the first embodiment. The UE 100 includes a receiver 110, a transmitter 120, and a controller 130. The UE 100 may include a reader/writer 140. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

The reader/writer 140 includes a Radio Frequency identifier (RFID) antenna 141. The reader/writer 140 communicates with the wireless tag 300 via the RFID antenna 141 under control of the controller 130. The reader/writer 140 communicates with the wireless tag 300 using the RFID technology. The RFID technology is a technology for writing or reading data to and from the wireless tag 300 in a non-contact manner using radio waves or electromagnetic fields. The reader/writer 140 can also cause the wireless tag 300 to generate electric power using radio waves or electromagnetic fields transmitted from the RFID antenna 141. The UE 100 is capable of wireless communication with the wireless tag 300 via the reader/writer 140. Note that the reader/writer 140 may have only a reader function without a writer function.

Note that the reader/writer 140 can also perform wireless communication with the wireless tag 300 using a communication protocol in accordance with the 3GPP. In this case, instead of the RFID antenna 141, an antenna capable of transmitting and receiving a radio signal having a frequency used for the 3GPP may be included in the reader/writer 140. The reader/writer 140 can also perform wireless communication with the wireless tag 300 using backscattering (or backward scattering). In this case, an antenna capable of transmitting and receiving a frequency signal used in the backscattering may be included in the reader/writer 140. Note that backscattering is described in detail later.

### Configuration Example of gNB

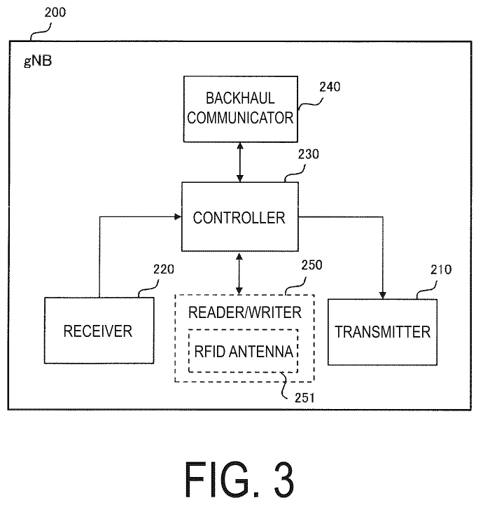

FIG. 3 is a diagram illustrating a configuration example of the gNB 200 (base station) according to the first embodiment. The gNB 200 includes a transmitter 210, a receiver 220, a controller 230, and a backhaul communicator 240. The gNB 200 may include a reader/writer 250. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via an Xn interface, which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and the two units may be connected via an F1 interface, which is a fronthaul interface.

The reader/writer 250 includes an RFID antenna 251. The reader/writer 250 communicates with the wireless tag 300 via the RFID antenna 251 under control of the controller 230. The reader/writer 250 writes and reads data to and from the wireless tag 300 in a non-contact manner using radio waves or electromagnetic fields transmitted from the RFID antenna 251. The reader/writer 250 can also cause the wireless tag 300 to generate electric power using radio waves or electromagnetic fields transmitted from the RFID antenna 251. The gNB 200 is capable of wireless communication with the wireless tag 300 via the reader/writer 250. Note that the reader/writer 250 may have only the reader function without the writer function.

Note that the reader/writer 250 can also perform wireless communication with the wireless tag 300 using a communication protocol in accordance with the 3GPP. In this case, instead of the RFID antenna 251, an antenna capable of transmitting and receiving a radio signal having a frequency used for the 3GPP may be included in the reader/writer 250. The reader/writer 250 can also perform wireless communication with the wireless tag 300 using backscattering. In this case, an antenna capable of transmitting and receiving a frequency signal used in the backscattering may be included in the reader/writer 250.

### Configuration Example of Wireless Tag

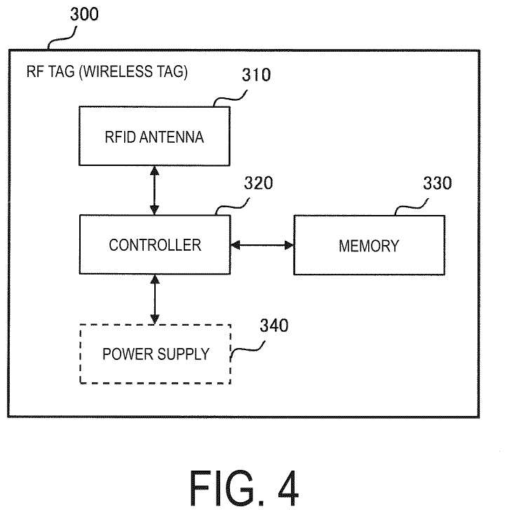

FIG. 4 is a diagram illustrating a configuration example of the wireless tag 300 according to the first embodiment. The wireless tag 300 includes an RFID antenna 310, a controller 320, and a memory 330. The wireless tag 300 may include a power supply 340.

The RFID antenna 310 performs wireless communication with the UE 100 or the gNB

200 using the RFID technology. As described above, the RFID technology includes a radio wave type and an electromagnetic induction type.

The radio wave type is a type of transmitting energy and signals using radio waves. In this case, the RFID antenna 310 receives radio waves transmitted from the UE 100 or the gNB 200, and a rectifier circuit provided in the RFID antenna 310 outputs part of the radio waves as DC power supply to the controller 320. This causes the controller 320 to operate. The RFID antenna 310 converts the received radio wave into a reception signal by a demodulation circuit or the like provided in the RFID antenna 310, and outputs the reception signal to the controller 320. Note that the RFID antenna 310 converts a transmission signal received from the controller 320 into a radio signal by a modulation circuit or the like provided in the RFID antenna 310, and transmits the radio signal to the UE 100 or the gNB 200. In this case, the RFID antenna 310 may transmit the radio signal by using a reflected wave of a received radio wave received from the UE 100 or the gNB 200.

The electromagnetic induction type is a type of causing an antenna coil to generate an electromagnetic field by electromagnetic induction and transmitting energy and signals. For the electromagnetic induction type, the RFID antenna 310 is a loop coil antenna. Both the RFID antenna 141 in the UE 100 and the RFID antenna 251 in the gNB 200 are loop coil antennas. The electromagnetic induction type is similar to and/or the same as the radio wave type in that power supply to the controller 320 is obtained by a rectifier circuit, a reception signal is obtained by a demodulation circuit, and a reflected wave may be used.

The controller 320 receives a reception signal from the RFID antenna 310. For example, the controller 320 writes data included in the reception signal to the memory 330 in accordance with indication information included in the reception signal. The controller 320 reads data from the memory 330 in accordance with the indication information included in the reception signal, for example. The controller 320 outputs a transmission signal including the read data to the RFID antenna 310. In the example described below, operations or processing in the wireless tag 300 may be performed by the controller 320.

The memory 330 stores an identifier of the wireless tag 300 (or identification information of the wireless tag 300. Hereinafter, the “identifier” and the “identification information” are not distinguished form each other in some cases), data, and the like. The memory 330 of the wireless tag 300 may adopt the Electronic Product Code (EPC) Class 1 Generation 2 (GEN2) standard conforming to ISO/IEC 18000-63. The memory 330 of the EPC GEN2 standard has four memory areas of a USER memory, a Tag ID (TID) memory, an EPC memory, and a RESERVED memory. The USER memory is an area that can be freely written to and read from by a user using the wireless tag 300. The TID memory is an area that a manufacturer, model information, and the like of the wireless tag 300 are written. The TID memory is a readable and non-writable area. The EPC memory is an area that the identifier of the wireless tag 300 is written. The RESERVED memory is an area that password information of the wireless tag 300 is written. The password information includes password information used to lock writing to the wireless tag 300 and password information used to Kill the wireless tag 300.

The power supply 340 is, for example, a power supply using energy harvesting. An environment for harvesting includes heat, vibration, motion, light, wind, radio wave, or biotechnology. The energy harvesting is a power generation method in which an electromotive force is obtained from the surrounding environment as described above. The energy harvesting is different from a power generation method using a battery such as a secondary battery. However, the wireless tag 300 may be equipped with a battery to generate power by itself like an active tag. For this reason, the power supply 340 may be a battery power supply.

Note that the wireless tag 300 may have only the reader function of reading data or the like from the memory 330 without the writer function of writing data or the like to the memory 330.

The wireless tag 300 can also perform wireless communication with the UE 100 or the gNB 200 using a communication protocol in accordance with the 3GPP. In this case, instead of the RFID antenna 310, an antenna capable of transmitting and receiving a radio signal having a frequency used for the 3GPP may be included in the wireless tag 300.

Hereinafter, a communication method of the wireless tag 300 is described as using the RFID technology, but is not limited thereto. For example, the communication method of the wireless tag 300 may use a 3GPP-compliant communication protocol. The wireless tag 300 may perform communication by using backscattering.

### Protocol Stack

A configuration example of the protocol stack is described. Here, a configuration example of the protocol stack in the UE 100, the gNB 200, and the AMF 30 other than the wireless tag 300 is described.

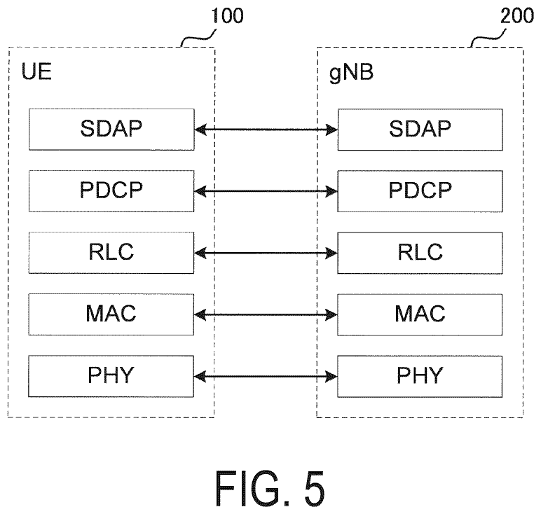

FIG. 5 is a diagram illustrating a configuration example of a protocol stack of a radio interface of a user plane handling data.

The radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

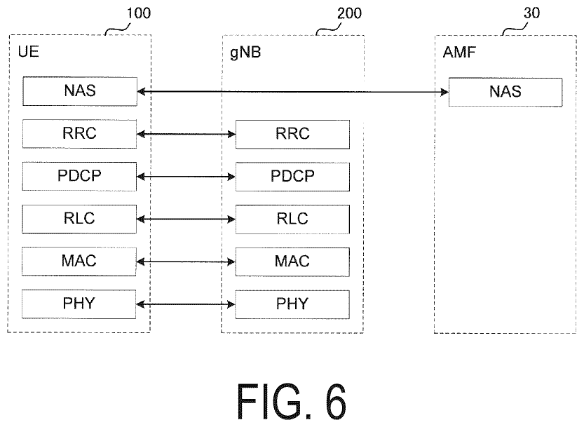

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 5.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is positioned upper than the RRC layer, performs session management, mobility management, and the like. NAS signaling is transmitted between the NAS of the UE 100 and the NAS of the AMF 30. Note that the UE 100 includes an application layer other than the protocol of the radio interface. A layer lower than the NAS is referred to as Access Stratum (AS).

### Passive IoT

The passive IoT is a technology that supports, for example, ultra-low power devices with ultra-low costs. Hereinafter, a device supporting the passive IoT may be referred to as a “passive IoT device”. The wireless tag 300 is an example of the passive IoT device.

The passive IoT device supports an ultra-low power device. Due to the low power consumption of the passive IoT, the passive IoT device may not need to use a battery or may use the energy harvesting.

Even the passive IoT devices may be equipped with a power supply. However, even such a case can be realized by a small-capacity battery and/or the energy harvesting on the premise of low power consumption, and thus low cost can be realized as compared with a device using a large-capacity battery.

On the other hand, since the passive IoT device performs communication using low power as compared with the UE 100 of the 5G system, a coverage range is narrow. A communication time is limited and an amount of data that can be transmitted and received at a time is small. In the passive IoT, interference may occur when multiple passive IoT devices communicate at the same time. Therefore, in the passive IoT, communication may be unstable and irregular.

The passive IoT may target the RFID, for example. Types of the RFID include a passive tag, an active tag, and a semi-passive tag (or a semi-active tag). The passive tag is a wireless tag that uses radio waves from a reader as a power supply. The passive tag is assumed to be mainly used for the passive IoT. The active tag is a wireless tag that uses a battery built in the wireless tag as a power supply. The semi-passive tag is a wireless tag that normally operates as a passive tag and operates as an active tag in response to a request from a reader. The passive IoT may target, for example, the semi-passive tag or the active tag.

Targets for the passive IoT include the backscattering, for example. The backscattering refers to reflection of a radio wave, a particle, or a signal back to a direction from which the radio wave, the particle, or the signal came. As described above, the backscattering in the passive IoT is used in the communication method using the reflected wave. The wireless tag 300 can modulate a reflected wave to transmit data by using the reflected wave.

Further, the targets for the passive IoT include the energy harvesting, for example. As described above, the energy harvesting is the power generation in which power is obtained from the environment. For example, in the energy harvesting, energy such as vibration or heat is converted into electrical energy to generate power. The energy harvesting may include solar panels or windmills. The low power consumption of the passive IoT allows the energy harvesting to be used as a power supply. Unlike a battery, the energy harvesting does not need to be charged or replaced, and thus can operate for a long time without maintenance.

### Problem of Passive IoT

When the passive IoT can be accommodated in a mobile communication system conforming to the 3GPP, for example, the passive IoT device can be managed also in the NG-RAN 10 or the CN 20.

However, when the passive IoT is accommodated in the mobile communication system, some problems may be considered.

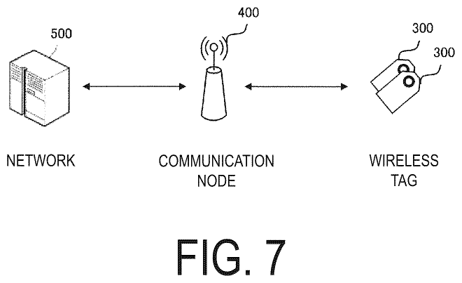

FIG. 7 is a diagram for explaining a problem in the passive IoT according to the first embodiment. In FIG. 7, a network 500 and a communication node 400 are included in the mobile communication system conforming to the 3GPP. The communication node 400 is a node that has the reader/writer function and communicates with the wireless tag 300. The communication node 400 may be the UE 100 or the gNB 200. On the other hand, the network 500 includes apparatuses communicating with the communication node 400. The network 500 is the CN 20 or the gNB 200.

When viewed from the network 500 (CN 20 or gNB 200), a problem is whether the wireless tag 300 is managed as a wireless tag or the UE 100. In the network 500, when the wireless tag 300 can be managed as the UE 100, the wireless tag 300 can be also handled in the same manner as the UE 100.

A problem is also whether the reader function (and/or writer function) is performed by the UE 100 or the gNB 200. Not only the UE 100 but also the gNB 200 can directly communicate with the wireless tag 300.

A further problem is whether the link between the communication node 400 and the wireless tag 300 uses existing specifications such as the RFID or uses the 3GPP-compliant communication protocol. Alternatively, a problem is whether a 3GPP-compliant communication band is used or a communication band for RFID (13.56 MHz band, 900 MHz band, or the like) is used.

As described above, there are several problems in order to accommodate the passive IoT in the mobile communication system. It will be understood that all or part of the above-described problems can be solved in the embodiments described below.

### Passive IoT Scenario

As scenarios in which passive IT is used, the following three scenarios (scenario a, scenario b, and scenario c) are assumed. Note that although the communication node 400 is present in the three scenarios, the communication node 400 may be, for example, either the UE 100 including the reader/writer 140 or the gNB 200 including the reader/writer 250.

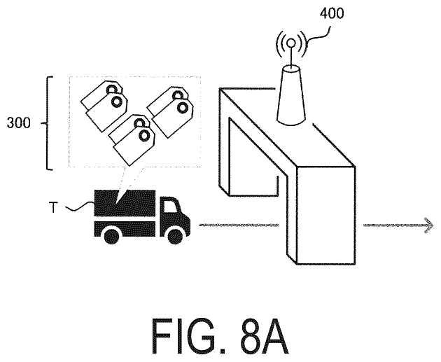

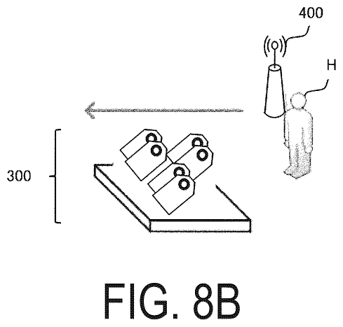

FIGS. 8A and 8B are diagrams for explaining the scenario a according to the first embodiment. The scenario a is, for example, a scenario in which the passive IoT is locally used.

As illustrated in FIG. 8A, when the wireless tag 300 loaded on a moving object such as a truck T (or a pallet) passes through a gate, the communication node 400 detects the wireless tag 300. The wireless tag 300 may be attached to each product. The wireless tag 300 may be attached to each pallet accommodating products. For example, the communication node 400 provided to a main gate of a factory detects the wireless tag 300, which enables management of products shipped from the factory or management of parts entering the factory.

An example of FIG. 8B is an example in which a moving object (e.g., a human H or a moving vehicle) moves the communication node 400 to detect the wireless tag 300 loaded on a fixed object (e.g., a pallet). The wireless tag 300 may be attached to each product. The wireless tag 300 may be attached to each pallet. The detection by the wireless tag 300 enables, for example, products loaded on a pallet to be managed.

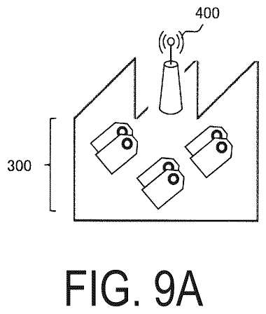

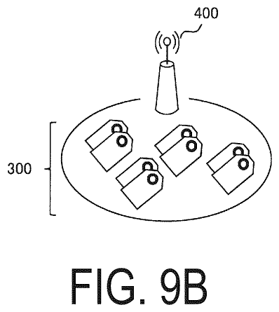

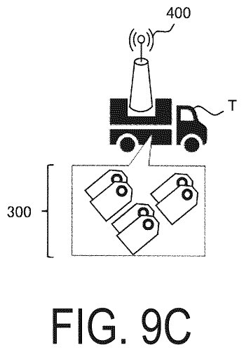

FIGS. 9A to 9C are diagrams for explaining the scenario b according to the first embodiment. The scenario b is a scenario for managing the wireless tag 300 existing in a certain location. The location may be a factory (or warehouse) (FIG. 9A), a particular area (FIG. 9B), or a load of the truck T (FIG. 9C). The communication node 400 manages the wireless tag 300 existing in the location, which enables inventory management of products or parts in the factory, management of products or part loaded on the truck T, and the like.

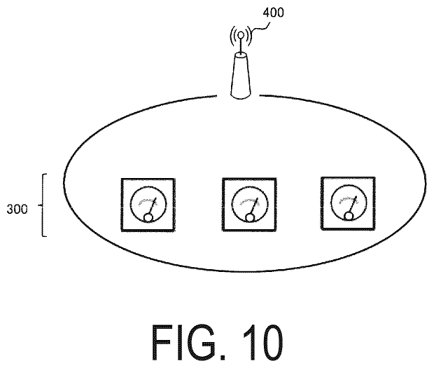

FIG. 10 is a diagram for explaining the scenario c according to the first embodiment. The scenario c is a scenario in which the wireless tag 300 disposed or existing in a certain location continuously or periodically reads a measurement value. For example, a thermometer and the wireless tag 300 connected to the thermometer are disposed in a site or a pasture. The wireless tag 300 can acquire a measurement value (temperature information) from the thermometer. Then, the communication node 400 continuously or periodically reads the measurement value from the wireless tag 300, which enables temperature management in the site, the pasture, or the like.

### Communication Control Method According to First Embodiment

A communication control method according to the first embodiment is described.

The first embodiment describes a protocol for managing the wireless tag 300 in the network 500.

Basically, the configuration illustrated in FIG. 7 is also applicable to the first embodiment. That is, the network 500 and the communication node 400 are accommodated in the mobile communication system, and the mobile communication system manages the wireless tag 300. In this case, the network 500 is the AMF 30 or the gNB 200. The communication node 400 is the gNB 200 or the UE 100. More specifically, combinations below are applicable.

That is, the network 500 may be the AMF 30 and the communication node 400 may be the gNB 200. In this case, the gNB 200 has the reader/writer function (that is, the reader/writer 250), and the gNB 200 communicates with the wireless tag 300. For example, an NG-AP message according to an NG-AP protocol is transmitted and received between the AMF 30 (network 500) and the gNB 200 (communication node 400).

In addition, the network 500 may be the AMF 30 and the communication node 400 may be the UE 100. In this case, the UE 100 has the reader/writer function (that is, the reader/writer 140), and the UE 100 communicates with the wireless tag 300. For example, a NAS message according to a NAS protocol is transmitted and received between the AMF 30 (network 500) and the UE 100 (communication node 400).

The network 500 may be the gNB 200 and the communication node 400 may be the UE 100. Also in this case, the UE 100 has the reader/writer function, and the UE 100 communicates with the wireless tag 300. For example, an RRC message according to an RRC protocol is transmitted and received between the gNB 200 (network 500) and the UE 100 (communication node 400).

Under such premises, in the first embodiment, first, a first communication node (e.g., the AMF 30 or the gNB 200) included in a network (e.g., the network 500) transmits a predetermined message (e.g., a paging message) to a second communication node (e.g., the communication node 400, that is the gNB 200 or the UE 100). Second, the second communication node transmits a tag information read from a wireless tag (e.g., the wireless tag 300) to the first communication node in response to receiving the predetermined message.

As described above, in the first embodiment, the second communication node reads the tag information from the wireless tag and transmits the tag information to the first communication node in response to receiving the predetermined message.

Thus, for example, as illustrated in the scenario b (FIGS. 9A to 9C), the communication node 400, with being triggered by receiving the paging message, can read the tag information from the wireless tag 300 disposed or existing in the certain location and transmit the tag information to the network 500. Therefore, the wireless communication system 1 according to the first embodiment can appropriately communicate with the wireless tag 300.

### Operation Example According to First Embodiment

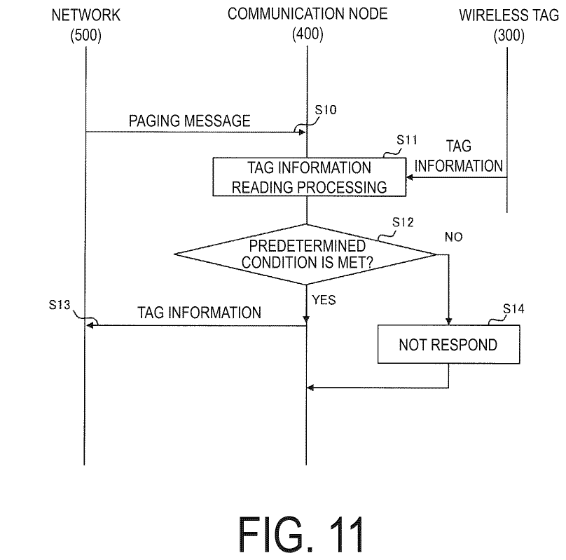

FIG. 11 is a diagram illustrating an operation example according to the first embodiment. Note that the operation example illustrated in FIG. 11 is described using the paging message as an example of the predetermined message. Before the operation illustrated in FIG. 11 is performed, the UE 100 is assumed to be in the RRC idle state or the RRC inactive state when the communication node 400 is the UE 100.

As illustrated in FIG. 11, in step S10, the network 500 transmits a paging message to the communication node 400.

When the network 500 is the AMF 30 and the communication node 400 is the UE 100, the paging message is transmitted as a NAS message. In this case, the paging is core network-initiated (CN-initiated). When the network 500 is the AMF 30 and the communication node 400 is the gNB 200, the paging message is transmitted as an NG-AP message. When the network 500 is the gNB 200 and the communication node 400 is the UE 100, the paging message is transmitted as an RRC message. In this case, the paging is access network-initiated (AN-initiated).

First, the paging message may include the identifier of the wireless tag 300 to be called (case A). The identifier may be an identification code used in the Electronic Product Code (EPC). The EPC is an identification code standardized by the GS1, which is a standardization organization. The EPC is a generic name of identification codes to be written in the wireless tag 300. The identification code in accordance with the EPC includes a Serialized Global Trade Item Number (SGTIN) used for managing goods or products, a Serialized Global Location Number (SGLN) used for managing locations, and a Global Returnable Asset Identifier (GRAI) used for managing assets such as pallets. Such an EPC-compliant identification code may be used as the identifier of the wireless tag 300.

A group of identifiers may be used as the identifiers of the wireless tags 300. For example, the identifiers of the wireless tags 300 may be a list of identification codes in accordance with the EPC. The RFID has an anti-collision function of collectively reading multiple wireless tags 300. The anti-collision function is a function of reading the tag information from each wireless tag 300 in a time division manner. This is because using a group of tag identifiers as the identifiers of the wireless tags 300 allows the wireless tags 300 to be collectively processed, which may be effective.

Second, the paging message may include an indicator indicating that the wireless tag 300 is to be called (case B). The indicator may be an indicator indicating that the tag information is to be read.

However, the identifier of the wireless tag 300 in the case A may indicate the “calling” the wireless tag 300 having this identifier. The identifier of the wireless tag 300 in the case A may indicate the “reading the tag information” from the wireless tag 300 having this identifier.

Note that the identifier to be called (case A) and the indicator indicating that the tag is to be called (case B) may be associated with the UEID. In this case, the network 500 performs paging to the UE 100 that manages the wireless tag 300 to be called and has the UEID, for example. When the communication node 400 is the gNB, the identifier to be called (case A) and the indicator indicating that the tag to be called (case B) may be associated with a gNB ID and/or a cell ID.

In step S11, the communication node 400 performs tag information reading processing in response to receiving the paging message. The communication node 400 may perform the reading processing in response to receiving the paging message including the identifier to be called (case A) or the indicator indicating that the tag is to be called (case B). The reading processing itself may utilize the RFID. The tag information read from the wireless tag 300 may be information stored in the EPC memory. That is, the tag information may be the identifier of the wireless tag 300. Alternatively, the tag information may be information stored in the TID memory (e.g., a manufacturer of the wireless tag 300). Alternatively, the tag information may be information stored in the USER memory. For example, a measurement value stored in the USER memory (e.g., the temperature information) may be the tag information. The tag information may be a remaining battery level when the wireless tag 300 is an active tag. Alternatively, the tag information may be password information stored in the RESERVED memory.

In step S12, the communication node 400 determines whether a predetermined condition is met. When the communication node 400 determines that the predetermined condition is met (YES in step S12), the process proceeds to step S13. On the other hand, when the communication node 400 determines that the predetermined condition is not met (NO in step S12), the process proceeds to step S14.

The predetermined condition is a condition for determining whether to transmit the tag information read in the tag information reading processing to the network 500.

First, the predetermined condition is whether the identifier of the wireless tag 300 included in the tag information read from the wireless tag 300 (e.g., the identifier of the tag read from the EPC memory) matches the identifier of the wireless tag 300 to be called included in the paging message (case A). When the identifier of the wireless tag read from the wireless tag 300 matches the identifier of the wireless tag 300 to be called included in the paging message (YES in step S12), the process proceeds to step S13. On the other hand, when the tag information does not match the identifier (NO in step S12), the process proceeds to step S14.

Second, the predetermined condition is whether the reading of the tag information is successful when the indicator indicating that the wireless tag 300 is to be called is included in the paging message (in the case B). When the reading of the tag information is successful (YES in step S12), the process proceeds to step S13. On the other hand, when the reading of the tag information is failed (NO in step S12), the process proceeds to step S14.

In step S13, the communication node 400 transmits the tag information to the network 500. When the communication node 400 is the UE 100 and the network 500 is the gNB 200, the UE 100 (communication node 400) may transmit an RRC message including the tag information to the gNB 200 (network 500) to perform step S13. When the communication node 400 is the UE and the network 500 is the AMF 30, the UE 100 (communication node 400) may transmit a NAS message including the tag information to the AMF 30 to perform step S13. When the communication node 400 is the gNB 200 and the network 500 is the AMF 30, the gNB 200 (communication node 400) may transmit an NG-AP message including the tag information to the AMF 30 (network 500) to perform step S13.

In step S14, the communication node 400 does not respond to the paging message. Note that in step S14, the communication node 400 may transmit to the network 500 the message (e.g., RRC message, NAS message, or NG-AP message) including at least one selected from the group consisting of information indicating that the reading of the wireless tag 300 is failed, information indicating that no information is read from the wireless tag 300, and information indicating that the information read from the wireless tag 300 does not meet the predetermined condition.

### Variation 1 of First Embodiment

The first embodiment has described a paging message as an example of the predetermined message. The predetermined message may be a message other than a paging message.

For example, when the network 500 is the gNB 200 and the communication node 400 is the UE 100, the following applies.

First, instead of the paging message, an RRC reconfiguration (RRCReconfiguration) message may be transmitted (step S10). The RRC reconfiguration message includes the information included in the paging message (step S10) described in the first embodiment. The UE 100 (communication node 400) performs the tag information reading processing with being triggered by the receiving the RRC reconfiguration message (step S11). When the predetermined condition is met (YES in step S12), the UE 100 transmits an RRC Reconfiguration Complete message including the tag information to the gNB 200 (network 500) (step S13). The UE 100 may transmit UE assistance information (UEAssistanceInformation (UAI)) including the tag information to the gNB 200.

Second, instead of the paging message, an RRC reconfiguration message including a measurement configuration may be transmitted (step S10). The measurement configuration includes the wireless tag 300 as a Measurement Object. The measurement configuration may include a reporting condition (whether reporting is performed periodically (periodic) or when an event occurs (event triggered)) as a reporting configuration (Reporting Configurations). For example, the event is that the UE 100 periodically reads the tag information and reports when a predetermined condition is met. The predetermined event includes, for example, a case where the read tag information changes (e.g., an increase or decrease in the number of wireless tags). The measurement configuration may include the predetermined condition described in the first embodiment. The measurement configuration may include a condition for communication with the wireless tag 300. For example, whether the tag information is read periodically or when an event occurs is specified. The RRC reconfiguration message includes the information included in the paging message (step S10) described in the first embodiment. When the predetermined condition is met (YES in step S12) and the reporting condition is met, the UE 100 may transmit a Measurement Report including the tag information (step S13). Alternatively, when the reporting condition is met, the UE 100 may transmit the measurement report including the tag information without considering the predetermined condition (step S13).

Third, a new message may be transmitted from the gNB 200 to the UE 100 (step S10). The new message may be a message indicating the reading of the wireless tag 300, such as “Passive IoT read indication”. The new message may include the information including the paging message (step S10) described in the first embodiment.

The examples of the RRC message are as described above. Note that as an example of the RRC message, a system information block (SIB) may be used. The system information block (SIB) can be used also to specify a particular wireless tag group. However, when the network 500 is the AMF 30 and the communication node 400 is the UE 100, a NAS message (step S10) other than the paging message may be used.

When the network 500 is the AMF 30 and the communication node 400 is the gNB 200, an NG-AP message (step S10) other than the paging message may be used. In this case, the gNB 200 (communication node 400) may transmit a new message (such as TAG RESPONSE) including the tag information to the AMF 30 (network 500) (step S13).

### Variation 2 of First Embodiment

The first embodiment has been described on the premise that before the operation example illustrated in FIG. 11 is performed, the UE 100 is in the RRC idle state or the RRC inactive state when the communication node 400 is the UE 100. The UE 100 may be assumed to be in the RRC connected state. In this case also, the UE 100 may monitor the paging message (step S10). Alternatively, when the network 500 (AMF 30 or gNB 200) grasps the wireless tag 300 being subordinate to the UE 100, the network 500 may transmit a NAS message or RRC message (RRC dedicated signaling) corresponding to the paging message to the UE 100 in the RRC connected state (step S10).

### Second Embodiment

### A Second Embodiment is Described.

In the first embodiment, the communication node 400 reads the wireless tag 300 with being triggered by receiving the paging message. In the second embodiment, the communication node 400 transmits tag information with being triggered by receiving the paging message. In the second embodiment, the communication node 400 manages the subordinate wireless tag 300 more proactively than the first embodiment.

Specifically, first, the second communication node (e.g., the communication node 400) reads the tag information from the wireless tag (e.g., the wireless tag 300). Second, the second communication node transmits the tag information to the first communication node (e.g., the network 500) in response to receiving the predetermined message (e.g., a paging message) after the reading of the tag information.

Thus, for example, the communication node 400, with being triggered by receiving the paging message, can transmit the tag information of the wireless tag 300 disposed or existing in the certain location to the network 500 (e.g., the scenario b). Therefore, in the second embodiment, the wireless communication system 1 can appropriately communicate with the wireless tag 300 to appropriately acquire the tag information.

### Operation Example According to Second Embodiment

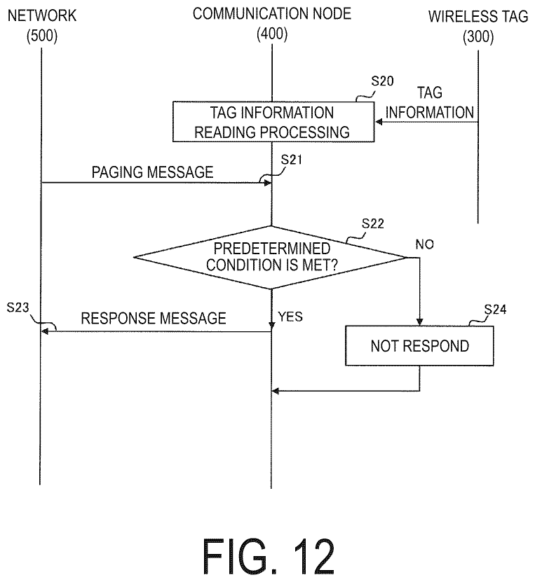

FIG. 12 is a diagram illustrating an operation example according to the second embodiment. Note that when the communication node 400 is the UE 100, before the operation example illustrated in FIG. 12 is started, the UE 100 is in the RRC idle state or the RRC inactive state as in the first embodiment.

As illustrated in FIG. 12, in step S20, the communication node 400 periodically performs the tag information reading processing on the wireless tag 300. The communication node 400 stores the read tag information in the memory.

In step S21, the network 500 transmits a paging message to the communication node 400. The paging message includes the information included in the paging message described in the first embodiment.

In step S22, the communication node 400 determines whether a predetermined condition is met. The predetermined condition includes a case where the case A (the paging message includes the identifier of the wireless tag 300 to be called) is met and a case where the case B (the paging message includes the indicator indicating that the wireless tag 300 is to be called) is met.

For example, the case A is as follows. That is, the predetermined condition is whether the identifier of the wireless tag 300 included in the paging message (step S21) is present in the identifiers of the wireless tags 300 read from the wireless tags 300 (or stored in the memory of the communication node 400). When the identifier of the wireless tag 300 included in the paging message is present in the identifiers of the wireless tags 300 read from the wireless tags 300 (YES in step S22), the process proceeds to step S23. When not present (NO in step S22), the process proceeds to step S24.

For example, the case B is as follows. That is, the predetermined condition is whether the identifier of the wireless tag 300 is present in the tag information read from the wireless tag 300. When the identifier of the wireless tag 300 is present in the tag information read from the wireless tag 300 (YES in step S22), the process proceeds to step S23. When not present (NO in step S22), the process proceeds to step S24.

In step S23, the communication node 400 responds to the paging message (step S21). That is, the communication node 400 transmits a response message including the tag information. The response message may be transmitted as any one of an RRC message, a NAS message, and an NG-AP message.

In step S24, the communication node 400 does not respond to the paging message (step S21). In this case, the communication node 400 may transmit to the network 500, as in the first embodiment, a message including any one of information indicating that the wireless tag 300 cannot be read, information indicating that no tag information is read from the wireless tag 300, and information indicating that the predetermined condition is not met. This message may also be transmitted as any one of an RRC message, a NAS message, and an NG-AP message.

In the operation example illustrated in FIG. 12, the paging message (step S21) has been described as an example. A message other than the paging message may be used as in the variation 1 of the first embodiment.

Also in the operation example illustrated in FIG. 12, when the communication node 400 is the UE 100, the UE 100 may be in the connected state, as in the variation 2 of the first embodiment. For example, the UE 100 may become the RRC connected state by the paging message, and then transmit the tag information to the network 500 (step S21) with being triggered by a NAS message or an RRC message (step S23). The NAS message or the RRC message, as in the first embodiment, includes the information included in the paging message (step S10 in FIG. 11) such as (a list of) the identifier(s) of the wireless tag(s) 300.

### Third Embodiment

### A Third Embodiment is Described.

In the third embodiment, the communication node 400 periodically reads the tag information from the wireless tag 300, and transmits the tag information when the tag information after the reading is changed from the tag information before the reading.

To be more specific, first, the first communication node (e.g., the AMF 30 or the gNB 200) included in the network (e.g., the network 500) configures a configuration of monitoring of the wireless tag (e.g., the wireless tag 300) for the second communication node (e.g., the communication node 400, that is the gNB 200 or the UE 100). Second, the second communication node periodically reads the tag information from the wireless tag in accordance with the configuration. Third, the second communication node transmits predetermined tag information to the first communication node when the tag information read from the wireless tag at a first timing is different from the tag information read from the wireless tag at a second timing subsequent to the first timing. The predetermined tag information includes either difference information indicating a difference between the tag information read at the first timing and the tag information read at the second timing or the tag information read at the second timing.

Thus, for example, the communication node 400 can appropriately communicate with the wireless tag 300 and appropriately transmit the changed tag information among the tag information read from the wireless tag 300 to the network 500. Therefore, the network 500 can also appropriately manage the tag information.

For example, in the scenario a (FIG. 8B), when there are multiple wireless tags 300 in the pallet, the communication node 400 periodically reads the tag information, and does not transmit the tag information when the tag information is not changed, or transmits the tag information when the tag information is changed. Thus, for example, when there is a new part in the pallet, the tag information can be read from the wireless tag 300 attached to the part, so that the new part can be appropriately managed.

Note that “when tag information is changed” is, for example, when the tag information read at the first timing is different from the tag information read at the second timing subsequent to (or after) the first timing.

### Operation Example According to Third Embodiment

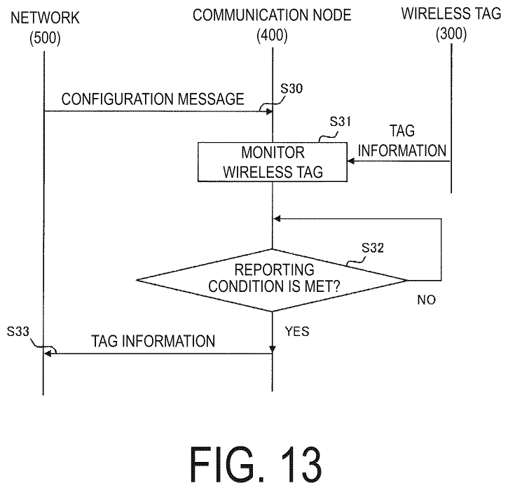

FIG. 13 is a diagram illustrating an operation example according to the third embodiment.

As illustrated in FIG. 13, in step S30, the network 500 transmits a configuration message to the communication node 400. This enables the network 500 to make a configuration of periodic tag monitoring for the communication node 400. The configuration message is transmitted as any one of an RRC message, an NAS message, and an NG-AP message. The configuration message includes at least one selected from the group consisting of information described below.

First, the configuration message may include a reading interval (or reading time). The reading interval may be a timer value. For example, the communication node 400 starts counting of a timer from the time of receiving the configuration message, and when the timer reaches the timer value and the timer expires, performs the reading processing on the wireless tag 300 and restarts the timer.

Second, the configuration message may include information indicating that the wireless tag 300 is to be periodically monitored. For example, the communication node 400 reads the tag information (at an implementation-dependent timing) in accordance with the indication.

Third, the configuration message may include an identifier of the wireless tag 300 to be periodically monitored. The communication node 400 monitors the wireless tag 300 having the identifier as a wireless tag to be periodically monitored.

Fourth, the configuration message may include information regarding the reporting condition. The reporting condition is whether to report every time the tag information read processing is performed (periodic) or whether to report only when the tag information is changed (event-trigger). In the periodic case, information indicating a reporting interval (or a timer value in some cases) is included. In the event-trigger case, a trigger for the reporting is when the tag information is changed. It may be when the measurement value obtained to be the tag information is changed. The trigger for reporting in the event-trigger case may be when the number of wireless tags 300 increases (or when the number of identifiers of the wireless tags 300 included in the read tag information increases as compared to that previously read). Alternatively, the trigger for reporting in the event-trigger case may be when the number of wireless tags 300 decreases (or when the number of identifiers of the wireless tags 300 included in the read tag information decreases as compared to that previously read).

Fifth, the configuration message may include information indicating reporting content. For example, information indicating that all of the read tag information is to be reported may be included. Alternatively, information indicating that the changed tag information is to be reported may be included. In this case, information indicating in which event the report is made may be included. For example, in accordance with the information, the communication node 400 can report to the network 500 information indicating that “the tag information is transmitted because a wireless tag #2 becomes ordinate to the communication node 400”.

In step S31, the communication node 400 monitors the wireless tag 300 in accordance with the configuration included in the configuration message. The communication node 400 reads the tag information from the wireless tag 300 in accordance with the configuration.

In step S32, the communication node 400 determines whether a reporting condition is met. When the reporting condition is met (YES in step S32), the process proceeds to step S33. On the other hand, when the reporting condition is not met (NO in step S32), step S32 is repeated until the reporting condition is met.

The reporting condition may be whether to report every time the tag information read processing is performed (periodic) or whether to report only when the tag information is changed (event-trigger), which is included in the configuration message (step S30). When the reporting condition is not included in the configuration message, for example, the reporting condition may be pre-configured. Note that when the tag information is not changed, the communication node 400 may report not the tag information but information indicating that the tag information is not changed.

In step S33, the communication node 400 transmits the tag information to the network 500. The transmitted tag information is predetermined tag information. The predetermined tag information may be difference information between the tag information read at the first timing and the tag information read at the second timing subsequent to (or after) the first timing. The predetermined tag information may be the tag information read at the second timing. The tag information may be included in an RRC message to be transmitted as in the first embodiment. The tag information may be included in a NAS message to be transmitted. The tag information may be included in an NG-AP message to be transmitted.

### Fourth Embodiment

### A Fourth Embodiment is Described.

The fourth embodiment is an embodiment in which the communication node 400 is the UE 100. The fourth embodiment describes an example in which, when the UE 100 detects a predetermined event, the UE 100 reads and transmits the tag information from the wireless tag 300 to the network 500 (AMF 30 or gNB 200).

Specifically, first, the user equipment (e.g., the UE 100) reads the tag information from the wireless tag (e.g., the wireless tag 300) in response detecting a predetermined event. Second, the user equipment transmits the tag information to the communication node (e.g., the AMF 30 or the gNB 200) included in the network (e.g., the network 500). Here, the predetermined event includes any one of Registration Area Update, Tracking Area Update, RAN-based Notification Area Update, handover, RRC connection reestablishment (RRC Reestablishment), RRC connection resume (RRC Resume), and RRC connection setup (RRC Setup).

Thus, as illustrated in the scenario b (FIG. 9C), for example, the UE 100 (communication node 400) can read and transmit the tag information from the wireless tag 300 to the network 500 at the timing when moving to a new Registration Area (RA) accompanying the truck T moving. Therefore, the wireless communication system 1 can read the tag information from the wireless tag 300 at an appropriate timing.

### Operation Example According to Fourth Embodiment

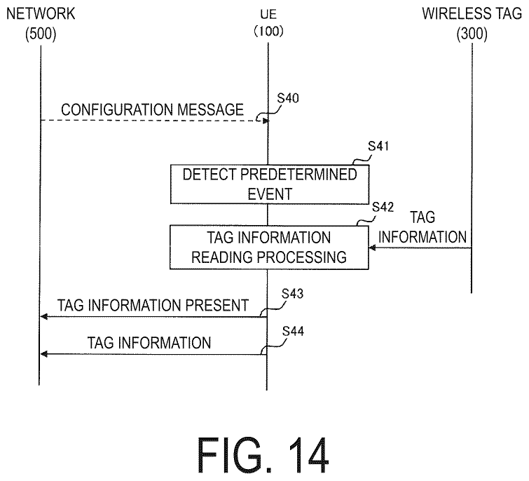

FIG. 14 is a diagram illustrating an operation example according to the fourth embodiment.

As illustrated in FIG. 14, in step S40, the network 500 may transmit a configuration message to the UE 100. The configuration message may be a message including information indicating that the tag information is permitted (or requested) to be transmitted. The configuration message is transmitted as an RRC message or a NAS message. For the RRC message, the configuration message may be broadcast by way of a System Information Block (SIB). The configuration message may be transmitted in the paging message described in the first embodiment.

In step S41, the UE 100 detects a predetermined event. The predetermined event includes the following, for example.

(1) First, the predetermined event includes at least one selected from the group consisting of a Registration Area Update (RAU), a Tracking Area Update (TAU), and a RAN-based Notification Area Update (RNAU). The tracking area (TA), which includes one or more cells, for example, is an area in which the UE 100 in the RRC idle state can move without updating MME. For example, the RAN-based notification area (RNA), which includes one or more cells, for example, is an area in which the UE 100 in the RRC inactive state can move without performing notification to the NG-RAN 10. The registration area (RA), which includes a plurality of tracking areas, for example, is an area in which the UE 100 can move without performing a registration procedure with the network. The predetermined event may be update processing performed when the UE 100 moves to such an area. Note that the TAU is performed between the UE 100 and the MME, but may be performed between the UE 100 and the AMF 30. A more specific description is given below.

### (1-1) When Network 500 is gNB 200

To be more specific, the predetermined event may include at least one selected from the group consisting of a time when the UE 100 transmits an RRC resume request (RRCResumeRequest) message, a time when the UE 100 receives an RRC resume (RRCResume) message, and a time when the UE 100 transmits an RRC resume complete (RRCResumeComplete) message in association with any of the RAU, the TAU, and the RNAU. The time when the UE 100 transmits or receives such a message may be the time of detecting the predetermined event.

### (1-2) When Network 500 is AMF 30

To be more specific, the predetermined event may include a time when the UE 100 transmits a REGISTRATION REQUEST message in association with the RAU and/or a time when the UE 100 receives a REGISTRATION ACCEPT message in association with the RAU. The time when the UE 100 transmits or receives such a message may be the time of detecting the predetermined event.

(2) Second, the predetermined event may be a handover. To be more specific, when the network 500 is the gNB 200, the predetermined event may include any one of a time when the UE 100 receives an RRC reconfiguration (RRCReconfiguration) message in association with a handover, a time when the UE 100 starts access to a target cell, and a time when the UE 100 transmits an RRC reconfiguration complete (RRCReconfigurationComplete) message in association with a handover. The time when starting the access to the target cell may include a time when starting a Random Access Channel (RACH) procedure and/or a time when completing the RACH procedure.

(3) Third, the predetermined event may be when the UE 100 performs RRC connection reestablishment. To be more specific, the predetermined event may include, when the network 500 is the gNB 200, at least one selected from the group consisting of a time when the UE 100 transmits an RRC reestablishment request (RRCReestablishmentRequest) message, a time when the UE 100 receives an RRC reestablishment (RRCReestablishment) message, and a time when the UE 100 transmits an RRC reestablishment complete (RRCReestablishmentComplete) message.

(4) Fourth, the predetermined event may be a time when the UE 100 resumes RRC connection. To be more specific, the predetermined event may include, when the network 500 is the gNB 200, at least one selected from the group consisting of a time when the UE 100 transmits an RRC resume request (RRCResumeRequest) message, a time when the UE 100 receives an RRC resume (RRCResume) message, and a time when the UE 100 transmits an RRC resume complete (RRCResumeComplete) message.

(5) Fifth, the predetermined event may be a time when the UE 100 sets up an RRC connection. To be more specifically, the predetermined event may include, when the network 500 is the gNB 200, at least one selected from the group consisting of a time when the UE 100 transmits an RRC setup request (RRCSetupRequest) message, a time when the UE 100 receives an RRC setup (RRCSetup) message, and a time when the UE 100 transmits an RRC setup complete (RRCSetupComplete) message.

In step S42, the UE 100 performs the tag information reading processing on the wireless tag 300 in response to detecting the predetermined event.

The UE 100, when succeeding in the reading of the tag information, transmits information indicating that the UE 100 has the tag information to the network 500 in step S43.

For example, when the network 500 is the gNB 200, the UE 100 transmits a message 3 (MSG3) and/or a message 5 (MGS5) in the RACH procedure including the information. The information may be, for example, “tag available”.

For example, when the network 500 is the AMF 30, the UE 100 transmits a NAS message including information indicating that the UE 100 has tag information.

The UE 100, when succeeding in the reading of the tag information, transmits the tag information (or a list of tag information) in step S44. For example, when the network 500 is the gNB 200, the UE 100 may transmit the message 5 in the RACH procedure including the tag information. The UE 100 may transmit the UE assistance information (UEAssistanceInformation) including the tag information. Note that in step S44, when the tag information includes a difference (specifically, the tag information acquired in the previous tag information reading processing is different from the tag information acquired in the current tag information reading processing), the UE 100 may transmit the tag information (that is, the tag information acquired in the current tag information reading processing). The UE 100 may transmit information on the difference.

The UE 100, when failing in the reading of the tag information in the tag information reading processing (step S42), may not need to perform step S43 and step S44. Alternatively, the UE 100, when failing in the reading of the tag information, may transmit a message (RRC message or NAS message) including information indicating that the reading of the tag information is failed to the network 500. Alternatively, the UE 100 may transmit a message (RRC message or NAS message) including information indicating that the wireless tag 300 has no tag information to the network 500.

### Fifth Embodiment

### A Fifth Embodiment is Described.

The fifth embodiment is an example in which the UE 100 attaches additional information to the tag information to be transmitted to the network 500 and transmits the tag information.

To be more specific, the second communication node (e.g., the UE 100 or the gNB 200 which is the communication node 400) transmits the tag information to which the additional information is added to the first communication node (e.g., the AMF 30 or the gNB 200 included in the network 500).

Thus, for example, the network 500 can appropriately manage a product or the like to which the wireless tag 300 is attached by using the additional information.

### Operation Example of Fifth Embodiment

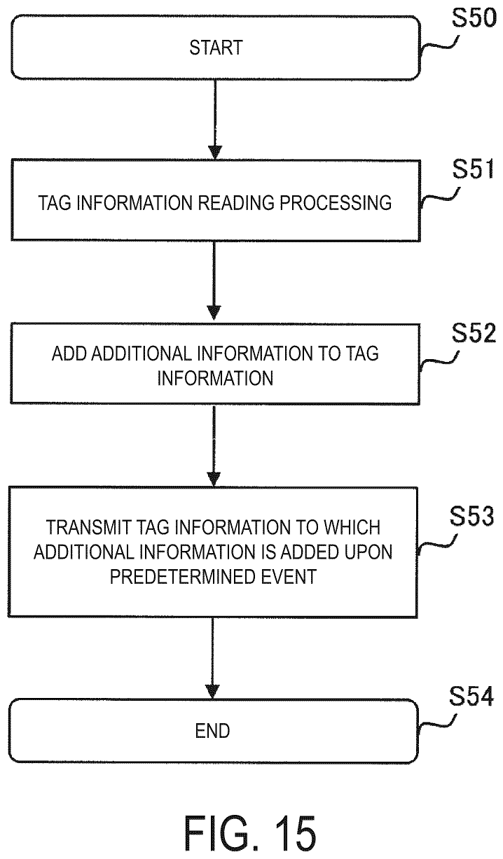

FIG. 15 is a flowchart illustrating an operation example according to the fifth embodiment. FIG. 15 illustrates processing mainly performed in the communication node 400 (UE 100 or gNB 200).

As illustrated in FIG. 15, in step S50, the communication node 400 starts the processing.

In step S51, the communication node 400 performs the tag information reading processing.

In step S52, the communication node 400 adds the additional information to the read tag information. The additional information may be, for example, at least one selected from the group consisting of information described below.

First, the additional information may be time information. The time information may be information indicating at least a time at which the communication node 400 reads the tag information. For example, the time information may be a date and time (date or time) when the communication node 400 reads the tag information. The time information may be a frame number of a radio frame at a time when the communication node 400 reads the tag information. When the communication node 400 is the gNB 200, the radio frame may be a radio frame used when the gNB 200 performs wireless communication with the UE 100. When the communication node 400 is the UE 100, the radio frame may be a radio frame used when the UE 100 performs wireless communication with the gNB 200.

Second, the additional information may be position information. The position information may be information indicating a location where the communication node 400 reads the tag information. For example, the position information may be represented by latitude and longitude. The position information may include altitude in addition to latitude and longitude. The position information may be represented by an RF fingerprint, for example. The position information may be position information obtained from beacon information such as Wi-Fi (trade name) or Bluetooth (trade name) in the surroundings.

Third, the additional information may be reception signal information regarding the reception signal. The reception signal information may be a received power of a signal received from the wireless tag 300 (e.g., Reference Signal Received Power (RSRP) and/or a received quality (e.g., Reference Signal Received Quality (RSRQ)). Alternatively, the reception signal information may be a propagation loss (path loss) of a signal received from the wireless tag 300. In this case, when a transmit power of the wireless tag 300 is known, the communication node 400 measures the received power of the signal received from the wireless tag 300, and acquires the propagation loss from [transmit power of wireless tag 300]—[received power in communication node 400]. When the received power of the wireless tag 300 can be fed back, the communication node 400 acquires the propagation loss from [transmit power of communication node 400 to wireless tag 300]—[received power in wireless tag 300]. In this case, for example, the wireless tag 300 stores a received power value in the USER memory, and the communication node 400 reads the information in the USER memory, thereby acquiring the received power value. When the wireless tag 300 transmits a transmission wave (reflected wave) by using backscattering, the communication node 400 can acquire the propagation loss from [transmit power of communication node 400]—[received power of communication node 400].

The additional information described above may be configured through a configuration message (any one of an RRC message, a NAS message, and an NG-AP message) transmitted from the network 500, and the communication node 400 may add the additional information to the tag information in accordance with the configuration. The configuration message may include information to be added as the additional information. When the information is, for example, the position information, the communication node 400 adds the position information as the additional information to the tag information.

In step S53, the communication node 400 transmits the tag information to which the additional information is added to the network 500 in response detecting a predetermined event.

The predetermined event may be the same as the predetermined event described in the fourth embodiment.

Then, in step S54, the communication node 400 ends the series of processing.

### Sixth Embodiment

### A Sixth Embodiment is Described.

The sixth embodiment is an embodiment in which the network 500 manages the acquired tag information in association with the communication node 400. The sixth embodiment is an embodiment in which the network 500 stores the tag information associated with the communication node 400 as a part of a context of the communication node 400.

To be more specific, the first communication node (e.g., the gNB 200 or the AMF 30 included in the network 500) manages the tag information in association with the second communication node (e.g., the UE 100 or the gNB 200 which is the communication node 400).

Thus, for example, in the network 500, since the tag information is associated with the communication node 400, the tag information can be appropriately managed. In addition, for example, the network 500 managing the tag information as a part of the contextual information of the UE 100 (UE Context) can also transmit the tag information as the part of the contextual information of the UE 100 to another network 500.

Note that the UE context information includes, for example, information capable of uniquely specifying the UE 100 in the gNB 200, such as a cell ID (Physical Cell ID (PCI) or the like) and/or a UE identifier (Cell-Radio Network Temporary Identifier (C-RNTI) or the like).

### Operation Example According to Sixth Embodiment

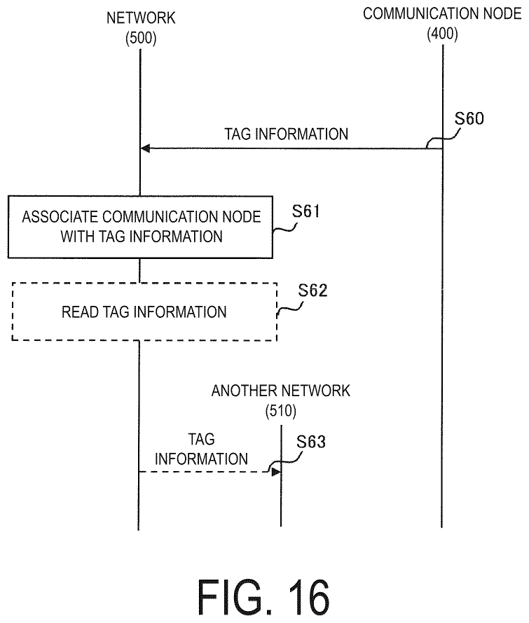

FIG. 16 is a diagram illustrating an operation example according to the sixth embodiment.

As illustrated in FIG. 16, in step S60, the communication node 400 transmits the tag information to the network 500. For example, the communication node 400 transmits by using any one of an RRC message, a NAS message, and an NG-AP message as a message including the tag information, as in the first embodiment.

In step S61, the network 500 associates the tag information received from the communication node 400 with the communication node 400. For example, the network 500 may associate the tag information with the identification information of the communication node 400. The network 500 may store the tag information in the memory the tag information as (a part of) the context information of the communication node 400. The context information of the communication node 400 includes, for example, the identification information of the communication node 400.

In step S62, the network 500 may read the tag information upon a predetermined read event. The predetermined read event may be paging. This is because the tag information is used to specify the communication node 400 that manages the wireless tag 300 that is a network call target when paging is performed in the network 500. The predetermined read event may be communication with the wireless tag 300. This is because the tag information is used to specify the communication node 400 that manages the wireless tag 300 when the communication is performed in the network 500.

In step S63, the network 500 may transmit to another network 510 the tag information as the contextual information of the communication node 400 upon a predetermined transmission event. The predetermined transmission event may be when the context information of the communication node 400 is requested by the other network 510. For example, the network 500 may transmit the tag information when requested by the other network 510 in the RAU, the TAU, the RNAU, the RRC connection reestablishment, the RRC connection resumption, or the like. The predetermined transmission event may be when transfer of the context information of the communication node 400 is requested to the other network 510. For example, the network 500 may transmit the tag information when transfer of the context information is requested by the other network 510 in association with a handover. Note that the network 500 may transmit the tag information (step S63) by transmitting any one of an Xn message including the tag information and an NG message including the tag information to the other network 510.

### Seventh Embodiment

### A Seventh Embodiment is Described.

The seventh embodiment is an embodiment in which the network 500 indicates to a specific communication node 400 that processing is to be performed on a specific wireless tag 300. The first embodiment has mainly described the reading processing on the wireless tag 300, whereas the seventh embodiment describes other processing than the reading processing.

To be more specific, first, the first communication node (e.g., the gNB 200 or the AMF 30) included in the network (e.g., the network 500) indicates to the second communication node (e.g., the UE 100 or the gNB 200 which is the communication node 400) an indication of processing on the wireless tag (e.g., the wireless tag 300). Second, the second communication node performs the processing on the wireless tag in accordance with the indication.

Thus, for example, the network 500 can perform processing on a specific wireless tag 300 via a specific communication node 400, including writing to the wireless tag 300, locking the wireless tag 300, or Killing the wireless tag 300. Therefore, the wireless communication system 1 can appropriately perform the specific processing on the specific wireless tag 300.

### Operation Example According to Seventh Embodiment

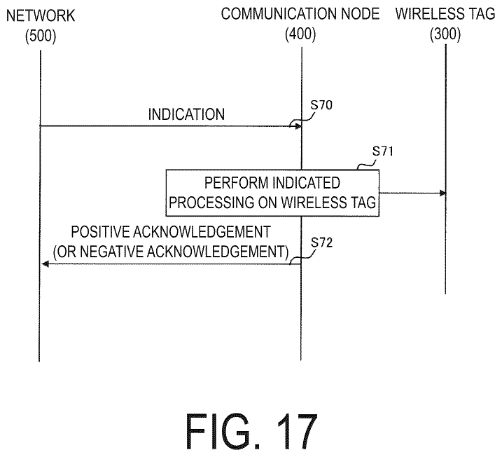

FIG. 17 is a diagram illustrating an operation example according to the seventh embodiment.

As illustrated in FIG. 17, in step S70, the network 500 indicates to the communication node 400 an indication of processing on the wireless tag 300. The network 500 may indicate the indication by transmitting any one of an RRC message, an NAS message, and an NG-AP message as a message including information indicating the indication. The RRC message may be an RRC reconfiguration (RRCReconfiguration) message, a system information (SIB), or a paging message as in the first embodiment.

The indication may include at least one selected from the group consisting of information described below.

First, the indication may include the identifier of the wireless tag 300. The identifier may be represented by the identification codes in accordance with the EPC as in the first embodiment. The identifier may be a list including multiple identifiers.

Second, the indication may include processing content for the wireless tag 300. The processing content may be information indicating reading of information stored in the wireless tag 300 as in the first embodiment. The processing content may be information indicating writing to the wireless tag 300. When the processing content is the writing to the wireless tag 300, data to be written may be included in the indication. In this case, information indicating writing for each piece of data may be included in the indication. When the processing content is the writing to the wireless tag 300, information indicating a memory area to which the processing content is written may be included in the indication. For example, the indication may include information indicating which memory is used among the EPC memory, the TID memory, the USER memory, and the RESERVED memory. When the processing content is the writing to the wireless tag 300, information indicating an attribute of the written data may be included. The attribute of the written data may include, for example, information indicating data, locking the wireless tag 300, or Killing the wireless tag 300.

In step S71, the communication node 400 receives the indication and performs the indicated processing on the wireless tag 300. The communication node 400, when receiving the indication, may anew read the tag information from the wireless tag 300 and confirm whether the wireless tag 300 indicated to be processed is present based on the read tag information. The communication node 400 may confirm whether the wireless tag 300 indicated to be processed is present based on the tag information having been already read from the wireless tag 300 at the time when receiving the indication. The communication node 400 may perform the processing indicated by the indication on the wireless tag 300 after confirming that the wireless tag 300 indicated to be processed is present.

The processing indicated by the indication may include, for example, writing to the wireless tag 300, locking the wireless tag 300, or Killing the wireless tag 300. In this way, the processing indicated by the indication may be processing indicating control over the wireless tag 300. The processing indicating the control also includes the indication of reading the wireless tag 300 described in the first embodiment. Thus, for example, the network 500 can perform the control over the wireless tag 300. In other words, according to the first and seventh embodiments, the control plane (signaling) can be established between the network 500 and the wireless tag 300.

In step S72, when the communication node 400 normally completes the indicated processing on the wireless tag 300, the communication node 400 transmits an acknowledgement indicating that the indicated processing is normally completed to the network 500. The acknowledgement may include the identifier of the wireless tag 300 on which the communication node 400 has performed the processing. The acknowledgement may include the tag information read by the communication node 400 in accordance with the indication.

On the other hand, in step S72, when the communication node 400 cannot normally complete the indicated processing on the wireless tag 300, the communication node 400 transmits a negative acknowledgement indicating that the indicated processing is not normally completed to the network 500. The negative acknowledgement may include the identifier of the wireless tag 300 on which the communication node 400 has performed the processing, like the acknowledgement. The negative acknowledgement may include information of Cause of the processing being not normally completed. The cause information includes any one or more of the wireless tag 300 being not subordinate, communication being not established with the wireless tag 300, the tag information of the wireless tag 300 being not read, and the tag information being not written to the wireless tag 300.

Note that the communication node 400 may transmit a message including the positive and negative acknowledgements to the network 500 by using any one of an RRC message, a NAS message, and an NG-AP message.

### Eighth Embodiment

### An Eighth Embodiment is Described.

The seventh embodiment has described the example in which the network 500 indicates to a specific communication node 400 that processing is to be performed on a specific wireless tag 300. The eighth embodiment is an embodiment for data exchange (user plane) with the wireless tag 300.

To be more specific, first, the first communication node (e.g., the gNB 200 or the AMF 30 in the network 500) configures a communication path associated with the identifier of the wireless tag (e.g., the wireless tag 300) subordinate to the second communication node (e.g., the UE 100 or the gNB 200 which is the communication node 400) for the second communication node. Second, the second communication node exchanges data with the wireless tag via the communication path.

Thus, for example, the network 500 can exchange data with the wireless tag 300 via the communication path associated with the identifier of the wireless tag 300. Therefore, the wireless communication system 1 can appropriately communication with the wireless tag 300.

### Operation Example According to Eighth Embodiment

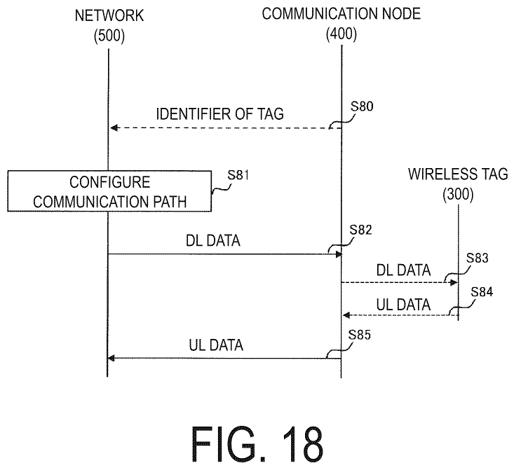

FIG. 18 is a diagram illustrating an operation example according to the eighth embodiment.

As illustrated in FIG. 18, in step S80, the communication node 400 may transmit the identifier of the wireless tag 300 subordinate thereto to the network 500. The communication node 400 may transmit a message including the identifier of the wireless tag 300 by using any one of an RRC message, a NAS message, and an NG-AP message.

In step S81, the network 500 transmits configures a communication path. The communication path may be a PDU session (between the UPF and the UE 100). The network 500 may be a QoS flow (between the UPF and the gNB 200, or between the gNB 200 and the UE 100). The communication path may be a radio access bearer (between the UPF and the gNB 200). The communication path may be a radio bearer (between the gNB 200 and the UE 100). An association configuration for associating the identifier of the wireless tag 300 with the communication path is made as follows, for example.

First, when the network 500 is the AMF 30, the AMF 30 may associate the PDU session with a PDU session ID and the identifier of the wireless tag 300. The AMF 30 may associate the QoS flow included in the PDU session with a QFI (QOS flow ID) and the identifier of the wireless tag 300.

Second, when the network 500 is the gNB 200, the gNB 200 may associate the radio bearer ID with the identifier of the wireless tag 300.

Noted that the communication path may be a network slice (a single network slice, a group, or a network slice type for reading tag information may be defined and used). The network slice is a virtual network configured by logically dividing a physical network constructed by a communication operator. In this case, the AMF 30 may make the association configuration by associating a slice identifier of the network slice identifier (Single Network Slicing Selection Assistance Information (S-NSSAI)) with the identifier of the wireless tag 300.

The network 500 may transmit a message including information of the association configuration to the communication node 400 by using any one of an RRC message, a NAS message, and an NG-AP message. Thus, the communication node 400 can acquire the information on the association configuration of the communication path.

In step S82, the communication node 400 receives DL data from the network 500 via the communication path.

In step S83, the communication node 400 transmits the received DL data to the wireless tag 300 associated with the communication path.

In step S84, the communication node 400 receives UL data from the wireless tag 300. For example, the communication node 400 may read the tag information from the wireless tag 300.

In step S85, the communication node 400 transmits the UL data to the network 500 via the communication path associated with the wireless tag 300.

Note that steps S84 and S85 may be performed before step S82 in terms of time.

### Ninth Embodiment

### A Ninth Embodiment is Described.

The ninth embodiment is an embodiment in which the communication node 400 notifies the network 500 that the wireless tag 300 is subordinate to the communication node 400.

To be more specific, the second communication node (e.g., the UE 100 or the gNB 200 which is the communication node 400) transmits passive link information regarding a passive link between the second communication node and the wireless tag (e.g., the wireless tag 300) to the first communication node (e.g., the gNB 200 or the AMF 30 in the network 500). Here, the passive link information includes at least one selected from the group consisting of information indicating that the wireless tag is subordinate to the second communication node, information indicating that the passive link is supported, and information indicating a protocol of the passive link.

Thus, for example, the network 500 can grasp the wireless tag 300 being subordinate to the communication node 400, and can appropriately perform processing on the wireless tag 300

### Operation Example According to Ninth Embodiment

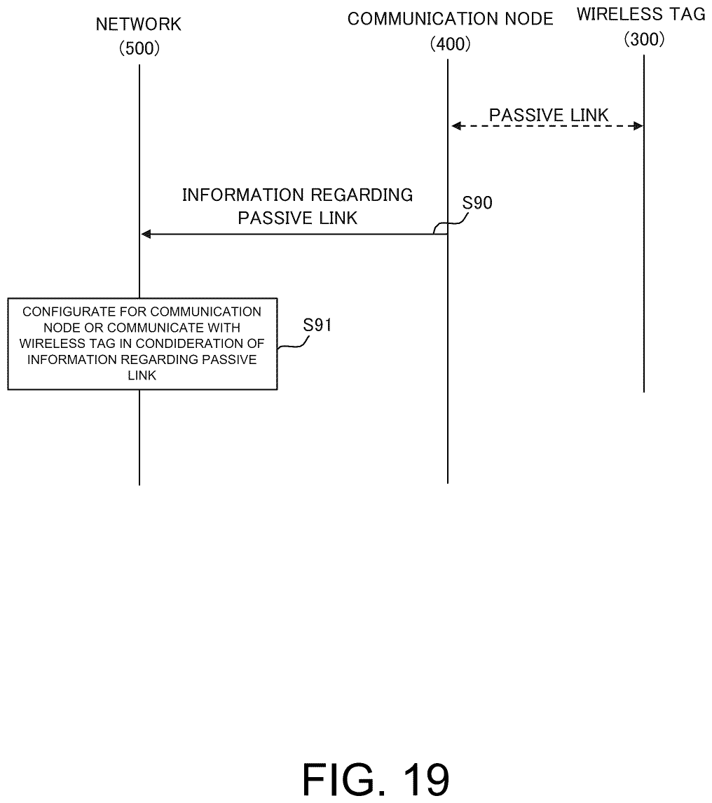

FIG. 19 is a diagram illustrating an operation example according to the ninth embodiment.

As illustrated in FIG. 19, in step S90, the communication node 400 transmits the passive link information regarding the passive link between the communication node 400 and the subordinate wireless tag 300 to the network 500. The passive link information may be information indicating that the wireless tag 300 is subordinate to the communication node 400. In this case, the passive link information may be, for example, the identifier of the wireless tag 300. The network 500, by receiving the passive link information including the identifier from the communication node 400, can grasp the wireless tag 300 being subordinate to the communication node 400. The passive link information may be information indicating that the passive link is supported between the communication node 400 and the wireless tag 300. In this case, the communication node 400 may transmit the information indicating that the passive link is supported as the passive link information as long as the communication node 400 can support the passive link regardless of whether the wireless tag 300 is subordinate to the communication node 400. The passive link information may be information indicating the protocol of the supported passive link. The information may include, for example, information indicating an RFID, information indicating Near Field Communication (NFC), or a standard name indicating the protocol. Note that the communication node 400 may transmit a message including the information regarding the passive link to the network 500 by using any one of an RRC message, a NAS message, and an NG-AP message.

In step S91, the network 500 makes either a configuration for the communication node 400 or communication with the wireless tag 300 via the communication node 400 in consideration of the passive link information.

### Other Embodiments

A program causing a computer to execute each of the processes performed by the UE 100, the gNB 200, or the AMF 30 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each of the processes performed by the UE 100, the gNB 200, or the AMF 30 may be integrated, and at least part of the UE 100, the gNB 200, or the AMF 30 may be configured as a semiconductor integrated circuit (a chipset or a System on a Chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated”, but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

### Supplementary Note

Features relating to the embodiments described above are described below as supplements.

(1)

A communication control method in a wireless communication system, the communication control method including:
a step of transmitting, by a first communication node included in a network, a predetermined message to a second communication node; and
a step of transmitting, by the second communication node, tag information read from a wireless tag to the first communication node in response to receiving the predetermined message.
   (2)

The communication control method according to (1) above, wherein
the step of transmitting to the first communication node includes a step of reading, by the second communication node, the tag information from the wireless tag in response to receiving the predetermined message, and a step of transmitting, by the second communication node, the tag information to the first communication node.
   (3)

The communication control method according to (1) or (2) above, further including
a step of reading, by the second communication node, the tag information from the wireless tag, wherein the step of transmitting to the first communication node includes a step of transmitting, by the second communication node, the tag information to the first communication node in response to receiving the predetermined message after the reading of the tag information.
   (4)

The communication control method according to any one of (1) to (3) above, wherein
the step of transmitting to the first communication node includes a step of transmitting, by the second communication node, the tag information to the first communication node when a predetermined condition is met, and
the predetermined condition is either when identification information of the wireless tag included in the predetermined message matches identification information of the wireless tag included in the tag information or when the reading of the tag information is successful.
   (5)

The communication control method according to any one of (1) to (4) above, wherein
the step of transmitting to the first communication node includes a step of transmitting, by the second communication node, the tag information to which additional information is added to the first communication node.
   (6)

The communication control method according to any one of (1) to (5) above, further including a step of managing, by the first communication node, the tag information in association with the second communication node.

(7)

The communication control method according to any one of (1) to (6) above, further including a step of transmitting, by the second communication node, passive link information regarding a passive link between the second communication node and the wireless tag to the first communication node.

(8)

The communication control method according to any one of (1) to (7) above, wherein
the passive link information includes at least one selected from the group consisting of information indicating that the wireless tag is subordinate to the second communication node, information indicating that the passive link is supported, and information indicating a protocol of the passive link.
   (9)

A communication control method in a wireless communication system, the communication control method including:
a step of performing, on a second communication node by a first communication node included in a network, a configuration of monitoring of a wireless tag;
a step of periodically reading, by the second communication node, tag information from the wireless tag in accordance with the configuration; and
a step of transmitting, by the second communication node, predetermined tag information to the first communication node when tag information read from the wireless tag at a first timing is different from tag information read from the wireless tag at a second timing subsequent to the first timing,
wherein the predetermined tag information includes either difference information indicating a difference between the tag information read at the first timing and the tag information read at the second timing or the tag information read at the second timing.
   (10)

A communication control method in a wireless communication system, the communication control method including:
a step of reading, by a user equipment, tag information from a wireless tag in response to detecting a predetermined event; and
a step of transmitting, by the user equipment, the tag information to a communication node included in a network,
wherein the predetermined event includes any one of Registration Area Update, Tracking Area Update, RAN-based Notification Area Update, handover, RRC connection reestablishment (RRC Reestablishment), RRC connection resume (RRC Resume), and RRC connection setup (RRC Setup).
   (11)

A communication control method in a wireless communication system, the communication control method including:
a step of performing, on a second communication node by a first communication node included in a network, an indication of processing on a wireless tag; and
a step of performing, by the second communication node, the processing on the wireless tag in accordance with the indication.
   (12)

The communication control method according to (11) above, further including
a step of transmitting, by the second communication node, either an acknowledgement indicating that the processing is normally completed or a negative acknowledgement indicating that the processing is not normally completed to the first communication node.
   (13)

The communication control method according to (11) or (12), further including:
a step of performing, on the second communication node by the first communication node, a configuration of a communication path, the communication path being associated with an identifier of the wireless tag subordinate to the second communication node; and
a step of exchanging, by the second communication node, data with the wireless tag via the communication path.
   (14)

The communication control method according to any one of (11) to (13), wherein
the step of exchanging includes a step of receiving, by the second communication node, the data from the first communication node via the communication path, and a step of transmitting, by the second communication node, the data to the wireless tag associated with the communication path.
   (15)

The communication control method according to any one of (11) to (14) above, wherein
the step of exchanging includes a step of receiving, by the second communication node, the data from the wireless tag, and a step of transmitting, by the second communication node, the data to the first communication node via the communication path.

### REFERENCE SIGNS

1: Wireless communication system
10: NG-RAN
20: 5GC (CN)
30: AMF
100: UE
110: Receiver
120: Transmitter
130: Controller
140: Reader/writer
141: RFID antenna
200: gNB
210: Transmitter
220: Receiver
230: Controller
250: Reader/writer
251: RFID antenna
300: Wireless tag
310: RFID antenna
320: Controller
330: Memory
340: Power supply
400: Communication node
500: Network

1. A communication control method in a wireless communication system, the communication control method comprising:
performing, on a second communication node by a first communication node comprised in a network, a configuration of monitoring of a wireless tag;
periodically reading, by the second communication node, tag information from the wireless tag in accordance with the configuration; and
transmitting, by the second communication node, predetermined tag information to the first communication node when tag information read from the wireless tag at a first timing is different from tag information read from the wireless tag at a second timing subsequent to the first timing,
wherein the predetermined tag information comprises either difference information indicating a difference between the tag information read at the first timing and the tag information read at the second timing or the tag information read at the second timing.

2. A communication control method in a wireless communication system, the communication control method comprising:
reading, by a user equipment, tag information from a wireless tag in response to detecting a predetermined event; and
transmitting, by the user equipment, the tag information to a communication node comprised in a network,
wherein the predetermined event comprises any one of Registration Area Update, Tracking Area Update, RAN-based Notification Area Update, handover, RRC connection reestablishment (RRC Reestablishment), RRC connection resume (RRC Resume), and RRC connection setup (RRC Setup).

3. A communication control method in a wireless communication system, the communication control method comprising:
performing, on a second communication node by a first communication node comprised in a network, an indication of processing on a wireless tag; and
performing, by the second communication node, the processing on the wireless tag in accordance with the indication.

4. The communication control method according to claim 3, further comprising
transmitting, by the second communication node, either an acknowledgement indicating that the processing is normally completed or a negative acknowledgement indicating that the processing is not normally completed to the first communication node.

5. The communication control method according to claim 3, further comprising:
performing, on the second communication node by the first communication node, a configuration of a communication path, the communication path being associated with an identifier of the wireless tag subordinate to the second communication node; and
exchanging, by the second communication node, data with the wireless tag via the communication path.

6. The communication control method according to claim 5, wherein
the exchanging comprises receiving, by the second communication node, the data from the first communication node via the communication path, and transmitting, by the second communication node, the data to the wireless tag associated with the communication path.

7. The communication control method according to claim 5, wherein
the exchanging comprises receiving, by the second communication node, the data from the wireless tag, and transmitting, by the second communication node, the data to the first communication node via the communication path.
